(19) United States
(12) Patent Application Publication
(10) Pub. No.: US 2008/0315635 A1
(43) Pub. Date: Dec. 25, 2008

(54) REAR END COLLISION SHOCK ABSORBING UNIT, RECLINING DEVICE, AND FRAMED STRUCTURE OF VEHICLE SEAT

(76) Inventors: Gakuji Kimura, Utsunomiya (JP); Yoshiaki Morita, Niwa (JP); Masaru Ueda, Komaki (JP)

Correspondence Address: Michael L. Crapenhoft;c/o Hiroe & Associates, 4-3 Usa 3-chome, c/o Hiroe & Associates, Gifu City, 500-8368, JP

(21) Appl. No.: 12/143,828

(22) Filed: Jun. 23, 2008

(30) Foreign Application Priority Data
Jun. 25, 2007 (JP) 2007-165851

(51) Int. Cl. B60R 21/00

(52) U.S. Cl. 297/216.1

(57) ABSTRACT

A rear end collision shock absorbing unit wherein there are provided one-side member rotating in synchronization with either one side of the seat back side and the seat cushion side between members that turn mutually to enable tilting, and the other-side member rotating in synchronization with the other side, and a convex part is provided on the one-side member, a concave part or a through hole in which the convex part fits is provided in the other-side member, and when a rear end collision shock is applied, the convex part and the concave part or through hole are turned relatively and deformed in a fitted state, whereby rear end collision shock energy is absorbed.

### BACKGROUND OF THE INVENTION

The present invention relates to a rear end collision shock absorbing unit used for a reclining device that tilts a seat back with respect to a seat cushion of a vehicular seat, the reclining device provided with the rear end collision shock absorbing unit, and a framed structure of the vehicular seat provided with the reclining device.

The vehicular seat provides a more comfortable seating state for a seated person generally because the seat back, which receives the back part of the seated person, can be tilted with respect to the seat cushion, which receives the seat part of the seated person, by using the reclining device, that is, the tilt angle of the seat back with respect to the seat cushion can be adjusted.

On the other hand, in the case where a rear end collision accident occurs on a vehicle, the seated person gets a rear end collision shock and is pushed against the seat back strongly. To reduce the influence of the rear end collision shock as much as possible, rear end collision shock absorbing techniques have been proposed in which the backward tilt of the seat back is gradually changed with respect to the seat cushion while absorbing the rear end collision shock.

FIG. 6a is a side view showing a vehicular shock absorbing seat that is background art to the present invention, which is one of the above-described rear end collision shock absorbing techniques, and FIG. 6b is a detailed view of an essential portion of the vehicular shock absorbing seat shown in FIG. 6a. This vehicular shock absorbing seat has been disclosed in Japanese Patent Application Publication No. 10-309968.

This vehicular shock absorbing seat 50 includes a seat cushion 41, a seat back 42 tiltable with respect to the seat cushion 41, and a head rest 43 provided above the seat back 42 so as to be capable of being put in and taken out.

A seat part frame 37, which is a skeleton of the seat cushion 41, and a back part frame 31, which is a skeleton of the seat back 42, are connected to each other by a back part base end frame 32 provided turnably in the end part of the seat part frame 37 so that the seat back 42 is tiltable with respect to the seat cushion 41.

In the above-described configuration, the vehicular shock absorbing seat 50 is characterized in that a part in which the back part frame 31 is fixedly connected to the back part base end frame 32 is used as a shock absorbing part 35.

The shock absorbing part 35, which is a lapping part of the back part base end frame 32 and the back part frame 31, includes a fuse mechanism 35a, a rebound restraining element 35b, and a fulcrum part 35c, which are provided at both ends and in the center in the lengthwise direction of the lapping part, and basically, fixedly fasten the back part base end frame 32 and the back part frame 31 with bolts and nuts.

The fuse mechanism 35a, the rebound restraining element 35b, and the fulcrum part 35c are arranged in the named order from the front side of the seat 50 (the left-hand side in FIG. 6a, the seat cushion 41 side) to the rear side thereof (the right-hand side in FIG. 6a, the seat back 42 side).

The fuse mechanism 35a includes a fuse bolt 31a that is inserted through a fixture hole, which is provided in the back part frame 31, without play, and an elongated fuse hole 32a, which consists of an insertion hole that is provided in the back part base end frame 32 to allow the fuse bolt 31a to be inserted through without play in the normal state (a state without rear end collision shock) and of a taper-shaped shock absorbing groove that is provided continuously with the insertion hole. The diameter of the taper-shaped shock absorbing groove increases so as to be once smaller than that of the insertion hole and gradually increase to the same diameter as that of the insertion hole.

The rebound restraining element 35b includes a rebound restraining bolt 31b, the smaller-diameter tip end side of which is inserted through a fixture hole provided on the back part frame 31 side without play and which is provided with a larger-diameter part on the lower side of the neck, and an elongated rebound restraining hole 32b, which consists of an insertion hole that allows the small-diameter tip end side of the rebound restraining bolt 31b to be inserted through without play in the normal state (a state without rear end collision shock), and of a large-diameter hole that is provided continuously with the insertion hole and allows the large-diameter lower part on the lower side of the neck of the rebound restraining bolt 31b to be inserted through without play when a rear end collision shock is absorbed.

The fulcrum part 35c includes a fulcrum bolt 31c, which is inserted through a fixture hole provided in the back part frame 31, without play, and a fulcrum hole 32c, that is provided in the back part base end frame 32 and always allows the fulcrum bolt 31c to be inserted through without play.

When the back part frame 31 receives a rear end collision shock (indicated by an outline type arrow in FIG. 6a), the back part frame 31 tilts backward with respect to the back part base end frame 32. At this time, in the shock absorbing part 35, the fuse mechanism 35a and the rebound restraining element 35b allow the back part frame 31 to tilt backward around the fulcrum part 35c in the range of the elongated holes, by which the rear end collision shock energy is absorbed during the backward tilting.

That is to say, the fuse mechanism 35a moves in the fuse hole 32a toward the large-diameter direction while the fuse bolt 31a expands and deforms the fuse hole 32a, so that the rear end collision energy applied backward is absorbed.

On the other hand, when the back part frame 31 tilts to the rearmost limit, the rebound restraining element 35b restrains the back part frame 31 from rebounding by the large-diameter lower part on the lower side of the neck of the rebound restraining bolt 31b fitted in the large-diameter hole of the rebound restraining hole 32b, by which the rebound energy is absorbed.

For the details of the shock absorbing part 35, refer to the description of Japanese Patent Application Publication No. 10-309968.

Thus, according to the vehicular shock absorbing seat 50 provided with the shock absorbing part 35, by the rebound restraining element, “the rebound motion of the upper body of the seated person is restrained reliably (paragraph [0060] of Japanese Patent Application Publication No. 10-309968)”, and also by the fuse mechanism, “the shock energy at the time of rear end collision is absorbed reliably (paragraph [0062] of Japanese Patent Application Publication No. 10-309968)”.

However, in this vehicular shock absorbing seat 50, the shock absorbing part 35 is provided integrally with the seat back frame (the back part frame 31 and the back part base end frame 32). That is to say, the shock absorbing part 35 is provided between the back part frame 31 and the back part base end frame 32, both of which are on the seat back 42 side. Therefore, the applicant of the present invention thought that this vehicular shock absorbing seat 50 has a problem in that the shock absorbing part 35 cannot be attached to a conventional seat after the seat has been assembled.

### SUMMARY OF THE INVENTION

The present invention has been made to solve the above problem, and accordingly an object thereof is to provide a rear end collision shock absorbing unit capable of being attached to an existing vehicular seat after the seat has been assembled while absorbing a rear end collision shock properly, a reclining device provided with the rear end collision shock absorbing unit, and a framed structure of a vehicular seat provided with the reclining device.

### BRIEF DESCRIPTION OF THE DRAWINGS

FIG. 1a is a side view schematically showing one example of a vehicular seat provided with a rear end collision shock absorbing unit in accordance with the present invention, and FIG. 1b is a partial detailed perspective view of the vehicular seat shown in FIG. 1a including a reclining device unit;

FIG. 2a is a perspective view of a reclining device provided with the rear end collision shock absorbing unit shown in FIG. 1b, being viewed from the seat cushion side, and FIG. 2b is an exploded perspective view of the rear end collision shock absorbing unit shown in FIG. 2a;

FIG. 3a is a front view of one-side member that the rear end collision shock absorbing unit shown in FIG. 2b has, FIG. 3b is a side view of the one-side member shown in FIG. 3a, FIG. 3c is a perspective view thereof, FIG. 3d is a front view of a reinforcing member that the rear end collision shock absorbing unit shown in FIG. 2b has, FIG. 3e is a side view of the reinforcing member shown in FIG. 3d, and FIG. 3f is a perspective view thereof;

FIG. 4a is a front view of the other-side member that the rear end collision shock absorbing unit shown in FIG. 2b has, FIG. 4b is a side view of the other-side member shown in FIG. 4a, FIG. 4c is a back view thereof, and FIG. 4d is a perspective view thereof;

FIGS. 5a-5c are explanatory views illustrating the operation and effect of the rear end collision shock absorbing unit shown in FIG. 2b, FIG. 5a being a front view in which the rear end collision shock absorbing unit at the normal time is viewed from the other side, FIG. 5b being an enlarged view showing a state in which a protrusion shown in FIG. 5a is fitted in a through hole, FIG. 5c being an enlarged view showing an initial state in which a rear end collision shock is delivered from the state shown in FIG. 5b, and FIG. 5d being an enlarged view showing a state in which the rear end collision shock is absorbed from the state shown in FIG. 5c; and

FIG. 6a is a side view showing a vehicular shock absorbing seat that is a background art of the present invention, and FIG. 6b is a detailed view of an essential portion of the vehicular shock absorbing seat shown in FIG. 6a.

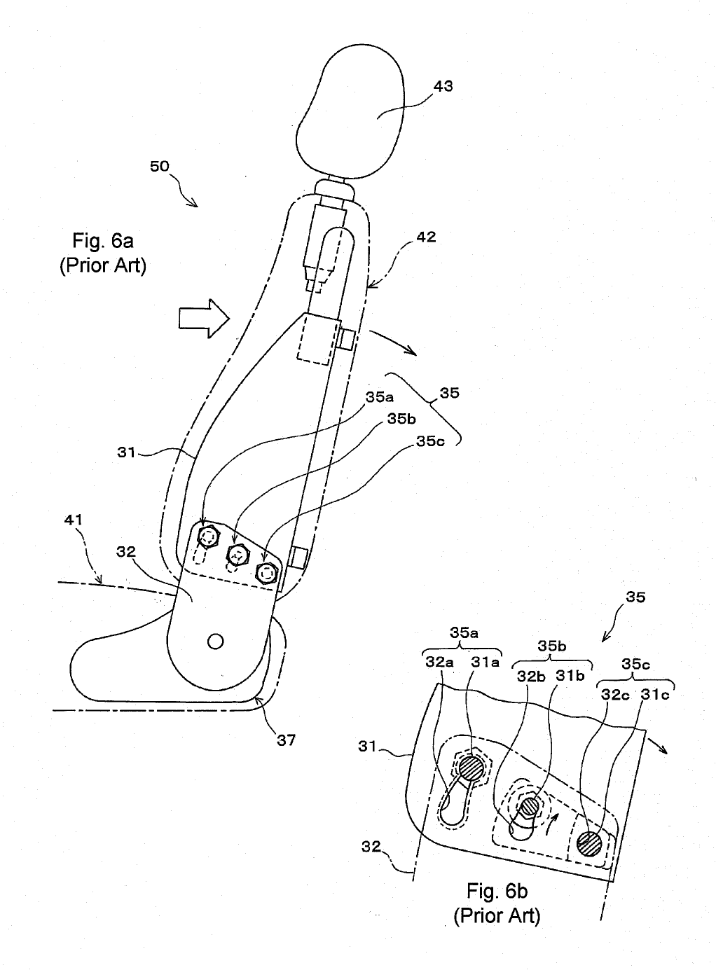

### DETAILED DESCRIPTION OF THE PREFERRED EMBODIMENTS

An embodiment (example) of the present invention will now be described with reference to the accompanying drawings.

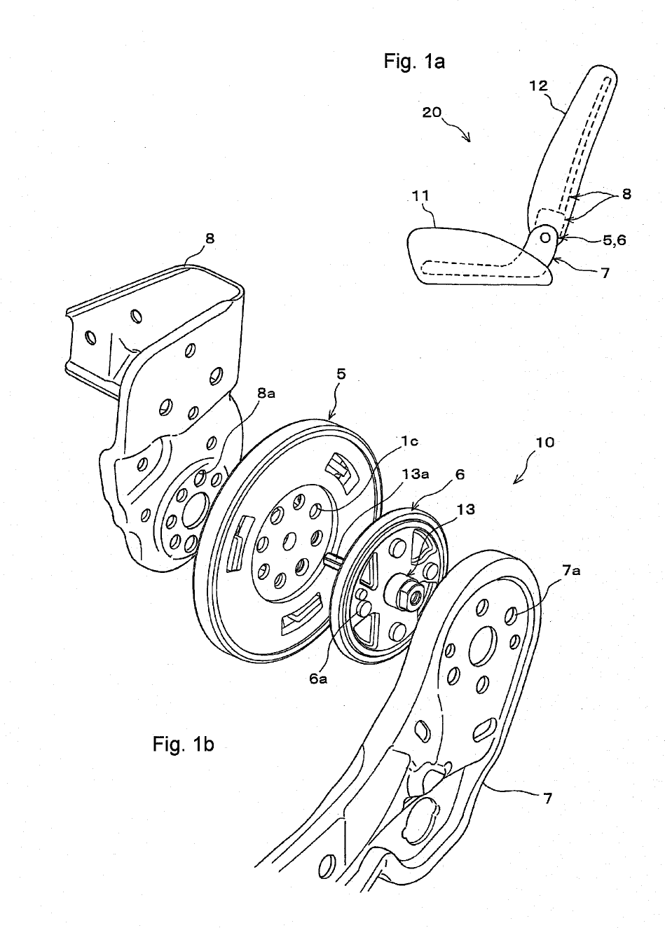

FIG. 1a is a side view schematically showing one example of a vehicular seat provided with a rear end collision shock absorbing unit in accordance with the present invention, and FIG. 1b is a partial detailed perspective view of the vehicular seat shown in FIG. 1a including a reclining device unit.

A vehicular seat 20 provided with a rear end collision shock absorbing unit in accordance with the present invention includes a seat cushion 11 receiving the seat part of a seated person, and a seat back 12 that receives the back part of the seated person and is capable of tilting with respect to the seat cushion 11.

A seat part frame 7, which is a skeleton of the seat cushion 11, and a back part frame 8, which is a skeleton of the seat back 12 are connected to each other by a reclining device 6 provided in the end part of the seat frame 7 so that the seat back 12 is tiltable with respect to the seat cushion 11.

As shown in FIG. 1b, a feature of the vehicular seat 20 is that a rear end collision shock absorbing unit 5 is provided on the seat back side of the reclining device 6, that is, between the reclining device 6 and the back part frame 8.

A turning shaft 13 is fixed to the reclining device 6, and is provided with a serration part 13a at the tip end thereof. This turning shaft 13 is inserted, so that the rotation phase can be adjusted, in a connection shaft (not shown) that connects so that the turning shaft 13 rotates in synchronization with a turning shaft 13 of the reclining device 6 used between the seat part frame 7 and the back part frame 8 on the opposite side of the vehicular seat 20.

In FIG. 1b, a plurality of protrusions 6a on the seat cushion side of the reclining device 6 fit in a plurality of through holes 7a in the seat part frame 7, by which the torque transmission and the coaxial property between the reclining device 6 and the seat part frame 7 are secured.

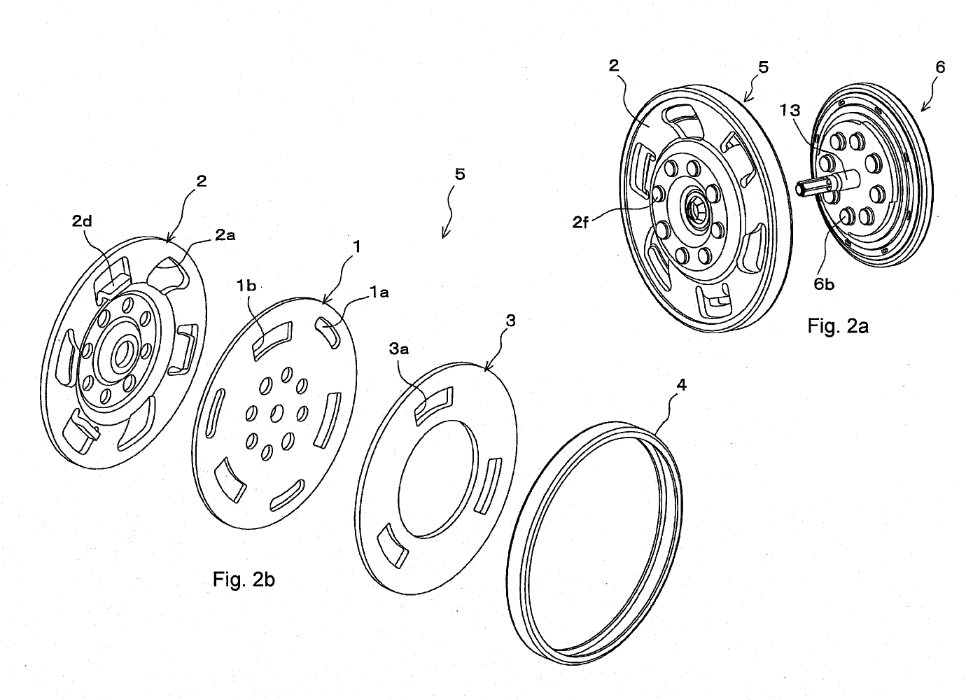

Also, a plurality of protrusions 6b (refer to FIG. 2a) on the seat back side of the reclining device 6 fit in a plurality of through holes 1c on the reclining device 6 side of the rear end collision shock absorbing unit 5, by which the torque transmission and the coaxial property between the reclining device 6 and the rear end collision shock absorbing unit 5 are secured.

Further, a plurality of protrusions 2f (refer to FIG. 2a) on the seat back side of the rear end collision shock absorbing unit 5 fit in a plurality of through holes 8a in the back part frame 8, by which the torque transmission and the coaxial property between the rear end collision shock absorbing unit 5 and the back part frame 8 are secured.

Thus, the transmission of torque relating to the tilting between the seat part frame 7 and the back part frame 8, between which the reclining device 6 and the rear end collision shock absorbing unit 5 are interposed, and the coaxial relationship between them is secured.

The relationship between the plurality of protrusions and through holes is made as described below. For example, in the case where the rear end collision shock absorbing unit 5 is provided between the reclining device 6 and the back part frame 8, the plurality of through holes 1c on the reclining device 6 side of the rear end collision shock absorbing unit 5 have the same positions and sizes as those of the plurality of through holes 8a on the reclining device 6 side of the back part frame 8.

Also, the plurality of protrusions 2f on the seat back side of the rear end collision shock absorbing unit 5 have the same positions and sizes as those of the plurality of protrusions 6b on the seat back side of the reclining device 6.

Therefore, in the case where the rear end collision shock absorbing unit 5 is not used, the plurality of protrusions 6b on the seat back side of the reclining device 6 are fitted in the plurality of through holes 8a on the reclining device 6 side of the back part frame 8, by which the torque transmission and the coaxial property between the reclining device 6 and the back part frame 8 are secured.

Therefore, the rear end collision shock absorbing unit 5 can be attached to the existing vehicular seat after the seat has been assembled, except for a problem of an axial space between the seat part frame 7 and the back part frame 8.

For the rear end collision shock absorbing unit 5, as described later, the axial thickness thereof can be decreased as far as possible in terms of the configuration thereof. Therefore, a difference in axial size between the case where the rear end collision shock absorbing unit 5 is provided and the case where it is not provided poses scarcely a problem associated with the assembly of the vehicular seat. Alternatively, in the case where the rear end collision shock absorbing unit 5 is not provided, a spacer for compensating the axial thickness of unit is interposed, which can solve the problem of a difference in axial size produced by the attachment of the rear end collision shock absorbing unit 5 after the seat has been assembled.

Also, as seen from the above description, the rear end collision shock absorbing unit 5 in accordance with the present invention not only can be provided on the seat back side of the reclining device 6 as in this example but also can be provided on the seat cushion side of the reclining device 6, that is, between the reclining device 6 and the seat part frame 7. In the latter case as well, the same effect can be achieved.

An assembly of the rear end collision shock absorbing unit 5, the reclining device 6, the seat part frame 7, and the back part frame 8 is called a framed structure 10 of the vehicular seat because it forms the skeleton part of the vehicular seat 20.

Hereunder, the configuration and components of the rear end collision shock absorbing unit 5 are explained.

FIG. 2a is a perspective view of a reclining device provided with the rear end collision shock absorbing unit shown in FIG. 1b, being viewed from the seat cushion side, and FIG. 2b is an exploded perspective view of the rear end collision shock absorbing unit shown in FIG. 2a. In these figures, the same symbols are applied to elements having been explained already, and the detailed explanation thereof is omitted.

In FIG. 2a, it is reconfirmed that the plurality of protrusions 6b on the seat back side of the reclining device 6 have the same positions and sizes as those of the plurality of protrusions 2f on the seat back side of the rear end collision shock absorbing unit 5.

As seen from FIGS. 2a and 2b, the rear end collision shock absorbing unit 5 is configured so that the other-side member 2, one-side member 1, and a reinforcing member 3 are arranged in the named order in the axial direction from the seat back side to the seat cushion side so as to be in contact with each other and to keep the coaxial property.

At this time, the other-side member 2, the one-side member 1, and the reinforcing member 3 are assembled so that turning restriction protrusions 2d of the other-side member 2 fit in turning restriction holes 1b in the one-side member 1 and in turning restriction holes 3a in the reinforcing member 3 so that convex parts 1a of the one-side member 1 fit in through holes 2a in the other-side member 2.

A cover 4 is provided to cover the outer periphery of the other-side member 2, the one-side member 1, and the reinforcing member 3 having been assembled as described above. Hereunder, the parts are explained in more detail.

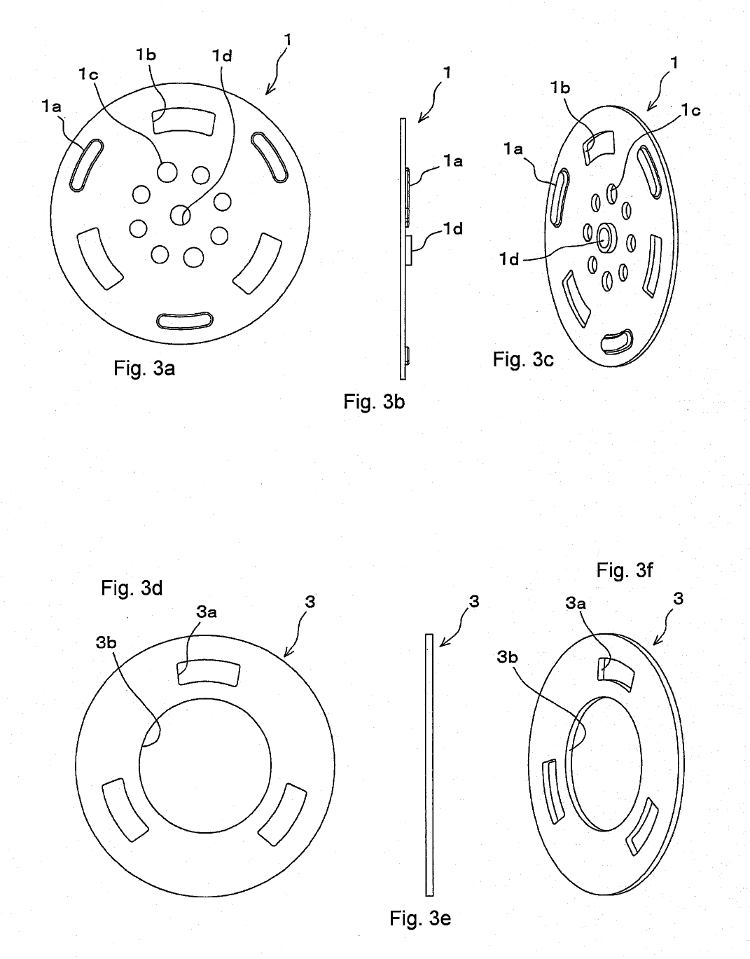

FIG. 3a is a front view of the one-side member that the rear end collision shock absorbing unit shown in FIG. 2b has, FIG. 3b is a side view of the one-side member shown in FIG. 3a, FIG. 3c is a perspective view thereof, FIG. 3d is a front view of the reinforcing member that the rear end collision shock absorbing unit shown in FIG. 2b has, FIG. 3e is a side view of the reinforcing member shown in FIG. 3d, and FIG. 3f is a perspective view thereof.

As shown in FIGS. 3a, 3b and 3c, the one-side member 1 has a disc shape, and is provided with the protrusions 1a each having a fixed length in the circumferential direction so as to divide the circumference at a fixed distance from the circle center of the one-side member 1 into three equal parts. Also, similarly, the turning restriction holes 1b having a fixed circumferential angle are provided as through windows so as to divide the circumference at a fixed distance from the circle center of the one-side member 1 into three equal parts.

The trisecting lines of the protrusions 1a and the trisecting lines of the turning restriction holes 1b do not have a positional relationship such as to divide the mating trisecting lines into two equal parts, and has a positional relationship such that each trisecting line shifts from the position at which the mating trisecting lines are divided into two equal parts through a certain angle. Therefore, as seen from FIG. 3a, regarding the circumferential space between the protrusion 1a and the turning restriction hole 1b, a wide space and a narrow space appear alternately.

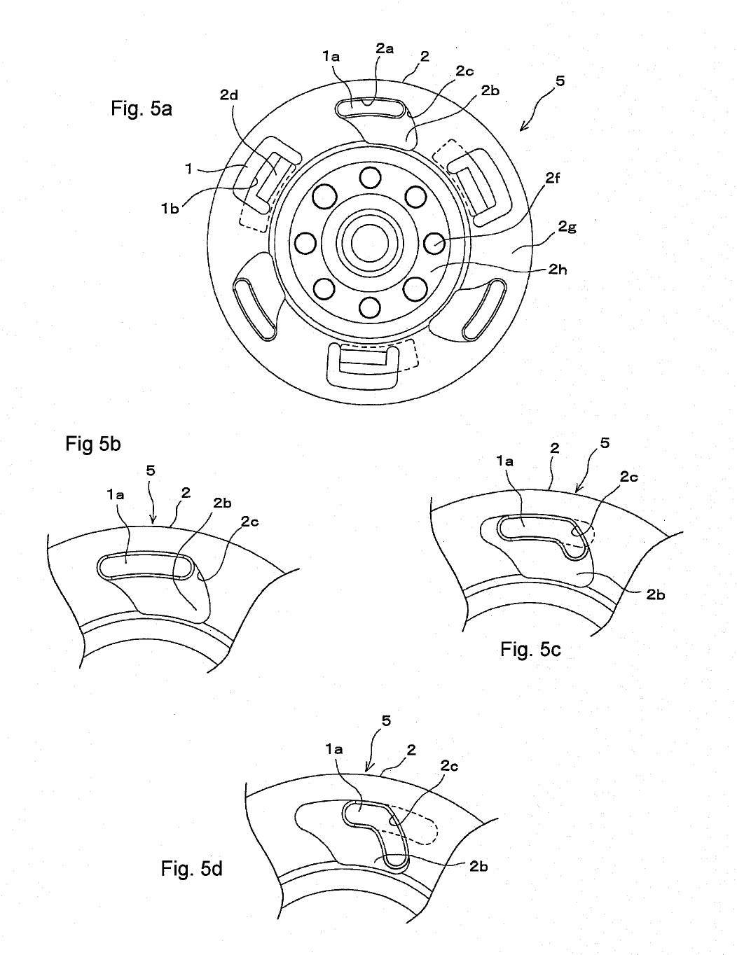

The reason why such a shift is provided will be described later with reference to FIG. 5a.

On the circle center side in the one-side member 1, the already-described plurality of through holes 1c are provided so as to divide the circumference into equal parts. The central part of the one-side member 1 forms a boss hole 1d projecting on the aforementioned protrusion 1a side.

The one-side member 1 is preferably made of a steel sheet having proper flexibility by sheet metal processing. At this time, the thickness of the steel sheet, which is a raw material, is determined considering the fact that the protrusions 1a formed by sheet metal processing is deformed by receiving a rear end collision shock and thereafter can absorb the rear end collision shock energy.

The one-side member 1 is rotated in synchronization with the reclining device 6 side, that is, the seat cushion side by fitting the plurality of through holes 1c on the plurality of protrusions 6b of the reclining device 6.

As shown in FIGS. 3d, 3e and 3f, the reinforcing member 3 has a disc shape, and is provided with turning restriction holes 3a each having the same position and size as each of the turning restriction holes 1b in the one-side member 1 and a relief hole 3b having an inside diameter slightly larger than the circumscribing circle of the plurality of through holes 1c in the one-side member 1.

The relief hole 3b provided in the reinforcing member 3 accommodates a disc protrusion part on the seat back side of the reclining device 6 connected to the reinforcing member 3.

As explained with reference to FIG. 2b, the reinforcing member 3 is assembled in contact with the side of the one-side member 1 on which the protrusions 1a are absent in a state of being coaxial with the one-side member 1 so as to be held between the one-side member 1 and the reclining device 6.

The reinforcing member 3 fills a gap produced on the outer peripheral side of the disc protrusion part in which the plurality of protrusions 6b on the seat back side of the reclining device 6 are provided, and eliminates an axial way to escape at the time when the protrusions 1a of the one-side member 1 receive rear end collision shock energy and are deformed so that the deformation progresses while sufficiently absorbing the rear end collision shock energy.

Therefore, the reinforcing member 3 is preferably made of a steel sheet by sheet metal processing, and the thickness of steel sheet, which is a raw material, is determined considering the role of filling the aforementioned gap.

Also, in the case where the reclining device 6 side does not produce a gap that provides an axial relief at the time when the protrusions 1a of the one-side member 1 deforms, this reinforcing member need not be provided.

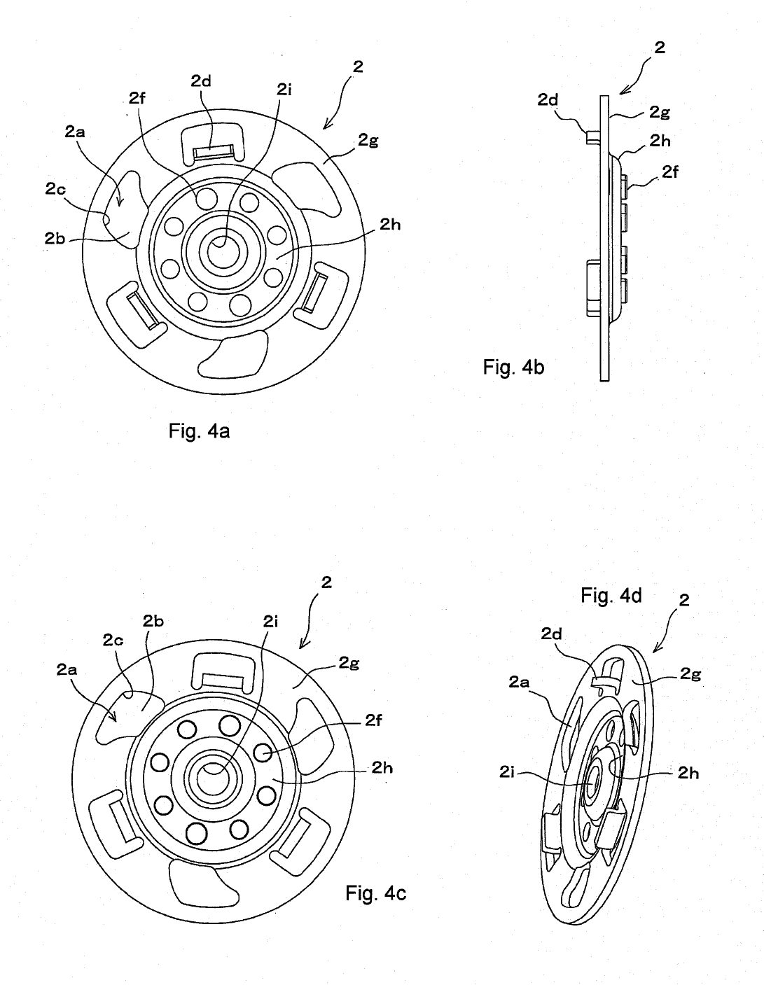

FIG. 4a is a front view of the other-side member that the rear end collision shock absorbing unit shown in FIG. 2b has, FIG. 4b is a side view of the other-side member shown in FIG. 4a, FIG. 4c is a back view thereof, and FIG. 4d is a perspective view thereof.

The other-side member 2 has a stepped disc shape having a difference in height between a center-side disc part 2h and an outer periphery-side disc part 2g, and is provided with the aforementioned through holes 2a and the turning restriction protrusions 2d in the outer periphery-side disc part 2g. The other-side member 2 is used in such a manner as to be directed so that the center-side disc part 2h is on the seat back side.

The through holes 2a are located in the outer periphery-side disc part 2g and are provided at positions at which the circumference at a fixed distance from the circle center of the other-side member 2 is divided into three equal parts so that at least the outer periphery side and both sides in the circumferential direction of the convex parts la of the one-side member 1 fit in the outermost periphery part of the through hole 2a without play.

As seen from the explanation given with reference to FIG. 5, the through hole 2a is provided with an excess space 2b capable of accommodating the deformed convex part 1a when the convex part 1a of the one-side member 1 is deformed.

Further, the through hole 2a is provided with a deformation guide part 2c that makes the relative shape of the through hole 2a with respect to the convex part 1a of the one-side member 1 desirable in terms of the time absorption ratio of rear end collision shock energy.

The turning restriction protrusions 2d are located in the outer periphery-side disc part 2g and are provided at positions at which the circumference at a fixed distance from the circle center of the other-side member 2 is divided into three equal parts so that the direction of the protrusion is on the side opposite to the height difference direction of the center-side disc part 2h (seat cushion side, reclining device 6 side).

The turning restriction protrusions 2d have a positional relationship such that when the one-side member 1 and the other-side member 2 are assembled as described above, the side part thereof on the side opposite to the direction in which the turning restriction protrusion 2d is turned by the rear end collision shock is close to the hole side face on the same side of the turning restriction hole 1b.

The turning restriction protrusion 2d is formed by blanking the outer periphery-side disc part 2g in a predetermined manner and thereafter by bending the protrusion 2d part toward the axial direction. Therefore, the thickness of the protrusion 2d part agrees with the thickness of a raw material for the whole of the other-side member 2.

The already-mentioned plurality of protrusions 2f are provided so as to further project from the center-side disc part 2h in the direction of the seat back side. In the center of the center-side disc part 2b, there is provided a center through hole 2i through which the turning shaft 13 passes.

The other-side member 2 is preferably made of a steel sheet having proper flexibility. At this time, the thickness of the raw material is determined considering the fact that the other-side member 2 has a strength so high that the through hole 2a deforms the convex part 1a of the one-side member 1 due to a rear end collision shock, and also has a strength so high as to regulate the turning to prevent the relative turning between the one-side member 1 and the other-side member 2 due to a rear end collision shock from further progressing by the regulation of the turning restriction protrusion 2d imposed by the turning restriction hole 1b in the one-side member 1 (also including the turning restriction hole 3a in the reinforcing member 3).

The other-side member 2 is used in the state in which the plurality of protrusions 2f fit in the plurality of through holes 8a in the back part frame 8. That is to say, the other-side member 2 turns in synchronization with the seat back side.

The operation and effect of the rear end collision shock absorbing unit 5 that is formed by assembling the one-side member 1, the other-side member 2, the reinforcing member 3, and the cover 4 described above in the state shown in FIG. 2b are explained.

FIG. 5 is explanatory views illustrating the operation and effect of the rear end collision shock absorbing unit shown in FIG. 2b, FIG. 5a being a front view in which the rear end collision shock absorbing unit at the normal time is viewed from the other side, FIG. 5b being an enlarged view showing a state in which a convex part shown in FIG. 5a is fitted in a through hole, FIG. 5c being an enlarged view showing an initial state in which a rear end collision shock is delivered from the state shown in FIG. 5b, and FIG. 5d being an enlarged view showing a state in which the rear end collision shock is absorbed from the state shown in FIG. 5c.

FIG. 5a shows the rear end collision shock absorbing unit 5 at the normal time that is viewed from the other side, that is, from the seat back side. If a rear end collision shock that tends to tilt the seat back 12 backward with respect to the seat cushion 11 is applied in this state, in FIG. 5a, a force that tends to turn the other-side member 2 (seat back side) in the counterclockwise direction with respect to the one-side member 1 (seat cushion side) is created.

At this time, the convex parts 1a of the one-side member 1 fit in the through holes 2a in the other-side member 2 to form a state in which mutual turning is impossible. However, if the rear end collision shock increases, the convex part 1a of the one-side member 1 is guided by the deformation guide part 2c of the through hole 2a in the other-side member 2, so that the convex part 1a of the one-side member 1 is deformed from the state shown in FIG. 5b to the state shown in FIG. 5c and to the state shown in FIG. 5d.

At this time, the rear end collision energy is absorbed as a bending distortion energy of plastic deformation into a chevron shape of the convex part 1a itself, and at this time, the deformed part is absorbed as shearing distortion energy such that a connecting part (indicated by a dotted line) with a base material part having been connected by the thickness of raw material of the one-side member 1 is sheared.

Also, since the through hole 2a is provided with the excess space 2b capable of accommodating the deformed convex part 1a when the convex part 1a is deformed, the deformation of the convex part 1a is not prevented from progressing further, and the convex part 1a can be deformed until the rear end collision shock is absorbed sufficiently.

Also, by properly adjusting the gradient with which the deformation guide part 2c of the through hole 2a is in contact with the convex part 1a, the time deformation degree of the convex part 1a, that is, the time absorption ratio of rear end collision shock energy can be made desirable.

Also, in the state shown in FIG. 5a, the turning restriction protrusion 2d of the other-side member 2 fits in the turning restriction hole 1b of the one-side member 1 (also including the turning restriction hole 3a in the reinforcing member 3) in the state in which the clockwise side is in contact and the counterclockwise side has a space, so that the other-side member 2 is allowed to turn in the counterclockwise.

The above-mentioned circumferential shift between the protrusion 1a and the turning restriction hole 1b of the one-side member 1 enables the above-described fitting.

Thus, by the above-described combination of the turning restriction protrusion 2d of the other-side member 2 and the turning restriction hole 1b in the one-side member 1, the process of rear end collision shock absorption due to the above-described engagement of the convex part 1a with the through hole 2a can be secured for a longer period of time.

In this example, the above-described shift between the turning restriction protrusion and the turning restriction hole is produced by a method in which the turning restriction hole 1b is shifted with respect to the protrusion 1a in the one-side member 1. However, inversely, even by a method in which the turning restriction protrusion is shifted with respect to the through hole in the other-side member, both of the members may share the shift.

Also, since the shock absorbing unit 5 is configured as a unit capable of being provided on the seat cushion side of the reclining device of the vehicular seat or on the seat back side thereof, the shock absorbing unit 5 can be attached to the reclining device part of the existing vehicular seat after the seat has been assembled by considering the size around the attachment part and the related parts.

Also, in this specification, an example in which the one-side member rotates in synchronization with the seat cushion side and the other-side member rotates in synchronization with the seat back side is shown. However, inversely, the configuration may be such that the one-side member rotates in synchronization with the seat back side and the other-side member rotates in synchronization with the seat cushion side. In this case as well, the shock absorbing unit configured as described above achieves the same operation and effect as those of the shock absorbing unit 5 of this example.

Also, the through hole provided in the other-side member may be formed as a concave part in which the convex part of the one-side member fits. In this case as well, the rear end collision shock absorbing unit including this concave part achieves the same effect.

Also, the reclining device provided with the above-described rear end collision shock absorbing unit achieves the effect of the shock absorbing unit as a reclining device.

Further, the framed structure of the vehicular seat having the reclining device provided with the shock absorbing unit (the framed structure is denoted by symbol 10 in FIG. 1) achieves the effect of the shock absorbing unit as the framed structure of the vehicular seat.

The shapes of the convex part of the one-side member and the concave part or through hole in the other-side member, in which the convex part fits and which are the feature of the present invention, can be configured not only to absorb the rear end collision shock energy but also to play the same role as that of the rebound restraining element described in Japanese Patent Application Publication No. 10-309968.

For example, if the relative shape of the outer periphery-side side faces of the convex part and the through hole is made a shape such as to mutually regulate the turning in the turning direction in which a rear end collision shock is applied and to allow the turning in the reverse direction, and inversely, the relative shape of the inner periphery-side side faces is made a shape such as to allow the turning in the turning direction in which a rear end collision shock is applied and to mutually regulate the turning in the reverse direction, both functions of rear end collision shock absorption and rebound restraint can be fulfilled.

Also, the rear end collision shock absorbing unit, the reclining device, and the framed structure of a vehicular seat in accordance with the present invention are not limited to the above-described example. Various modifications and combinations can be made in the scope described in claims and in the scope of example, and these modifications and combinations also fall within the scope of right of the present invention.

The rear end collision shock absorbing unit, the reclining device, and the framed structure of a vehicular seat in accordance with the present invention can be used in the industrial field in which the capability of properly absorbing a rear end collision shock while the rear end collision shock absorbing unit can be attached to the existing vehicular seat after the seat has been assembled is required.

What is claimed is:

1. A rear end collision shock absorbing unit used for a reclining device that tilts a seat back with respect to a seat cushion of a vehicular seat, wherein
there are provided one-side member rotating in synchronization with either one side of the seat back side and the seat cushion side between members that turn mutually to enable the tilting, and the other-side member rotating in synchronization with the other side, and
a convex part is provided on the one-side member; a concave part or a through hole in which the convex part fits is provided in the other-side member; and when a rear end collision shock is applied, the convex part and the concave part or through hole are turned relatively and deformed in a fitted state, whereby rear end collision shock energy is absorbed.

2. The rear end collision shock absorbing unit according to claim 1, wherein in the concave part or through hole in the other-side member, there is provided an excess space capable of accommodating the deformed convex part when the convex part on the one-side member is deformed.

3. The rear end collision shock absorbing unit according to claim 1, wherein the relative shape of the convex part on the one-side member and the concave part or through hole in the other-side member is made such that the time absorption ratio of rear end collision shock energy is desirable.

4. The rear end collision shock absorbing unit according to claim 2, wherein the relative shape of the convex part on the one-side member and the concave part or through hole in the other-side member is made such that the time absorption ratio of rear end collision shock energy is desirable.

5. The rear end collision shock absorbing unit according to claim 1, wherein the rear end collision shock absorbing unit is configured so as to be capable of being attached to the seat back side or the seat cushion side of the reclining device after the seat has been assembled.

6. The rear end collision shock absorbing unit according to claim 2, wherein the rear end collision shock absorbing unit is configured so as to be capable of being attached to the seat back side or the seat cushion side of the reclining device after the seat has been assembled.

7. The rear end collision shock absorbing unit according to claim 3, wherein the rear end collision shock absorbing unit is configured so as to be capable of being attached to the seat back side or the seat cushion side of the reclining device after the seat has been assembled.

8. The rear end collision shock absorbing unit according to claim 4, wherein the rear end collision shock absorbing unit is configured so as to be capable of being attached to the seat back side or the seat cushion side of the reclining device after the seat has been assembled.

9. A reclining device provided with the rear end collision shock absorbing unit according to claim 1.

10. A reclining device provided with the rear end collision shock absorbing unit according to claim 2.

11. A reclining device provided with the rear end collision shock absorbing unit according to claim 3.

12. A reclining device provided with the rear end collision shock absorbing unit according to claim 4.

13. A reclining device provided with the rear end collision shock absorbing unit according to claim 5.

14. A reclining device provided with the rear end collision shock absorbing unit according to claim 6.

15. A reclining device provided with the rear end collision shock absorbing unit according to claim 7.

16. A reclining device provided with the rear end collision shock absorbing unit according to claim 8.

17. A framed structure of a vehicular seat provided with the reclining device according to any one of claims 9-16.
